(19) United States
(12) Patent Application Publication
(10) Pub. No.: US 2026/0332565 A1
(43) Pub. Date: Oct. 22, 2026

(54) SYSTEMS AND METHODS FOR PROTECTING PORTIONS OF A DATASET WHEN COMMUNICATING WITH DEVICES OUTSIDE OF A DOMAIN

(71) Applicant: Capital One Services, LLC, McLean, VA (US)

(72) Inventors: Mitesh PATEL, Hawthorn Woods, IL (US); SrinivasRao ALAPARTHI, Elk Grove Village, IL (US); Ramachandra KANCHARLA, Glen Allen, VA (US); Rashmi SHARMA, Algonquin, IL (US); Abhimat VARMA, Avon, CT (US); Benjamin LEE, Plano, TX (US)

(73) Assignee: Capital One Services, LLC, McLean, VA (US)

(21) Appl. No.: 19/185,126

(22) Filed: Apr. 21, 2025

(51) Int. Cl. H04L 9/40; G06F 21/62

(52) U.S. Cl. CPC H04L 63/0428; G06F 21/6245

(57) ABSTRACT

Systems and method for protecting portions of a dataset when communicating with devices outside of a domain are disclosed. The method can involve obtaining entries from a first dataset, generating user identifiers and encrypted representations of portions of the data, and creating a second dataset by removing and encrypting certain subentries. This second dataset can then be provided to a device, which returns a third dataset that includes supplemental data. Upon decryption, an augmented dataset is generated by updating the original dataset or as a new dataset, reestablishing the original data and adding the supplemental data.

### BACKGROUND

Systems can be configured to encrypt datasets before providing them to a third party to establish confidentiality and security. Examples of techniques that can be implemented to do so include symmetric encryption, such as AES (Advanced Encryption Standard), which encrypts entire datasets using a single key, and asymmetric encryption, which employs public-private key pairs to secure data. Asymmetric encryption is particularly advantageous for securely sharing data with third parties, as it allows the sender to encrypt the dataset with the recipient’s public key, ensuring that only the recipient can decrypt it using their private key. To enhance security further, data-in-transit protocols like SSL/TLS are often employed alongside encryption to protect datasets during transmission. These approaches are widely adopted due to their ability to safeguard sensitive information while maintaining compatibility with various third-party systems.

However, encrypting datasets for third-party use poses several technical challenges. Key management is a critical issue, as securely generating, distributing, and storing encryption keys requires significant overhead and an established infrastructure. The complexity increases when asymmetric encryption is used, as this technique involves managing multiple keys for different recipients. Additionally, encrypted datasets can be difficult to process or analyze without decryption, potentially requiring additional computational resources or specialized tools to establish compatibility. Network communication can also become more resource-intensive when encrypted datasets are large or require frequent updates, as the added encryption layers increase data size and processing time.

### SUMMARY

Further exacerbating these technical issues, the encryption of datasets for third-party use becomes more complex when only portions of the data need to be encrypted while other parts remain unencrypted. This selective encryption approach introduces challenges in identifying and isolating sensitive fields or rows for encryption while ensuring that non-sensitive portions remain accessible for immediate use. Managing this separation often involves additional processing steps, such as tagging or flagging sensitive data, which can increase computational overhead. And maintaining the integrity of the dataset structure during encryption can be difficult, as encrypted portions may differ in size or format, potentially complicating compatibility with third-party systems. Network communication can also be impacted, as transmitting a mixed dataset requires careful handling to ensure that encrypted and unencrypted portions are properly synchronized and securely delivered without exposing sensitive information.

In view of these challenges, systems and methods described herein relate to novel uses and/or improvements in protecting portions of a dataset when communicating with devices outside of a domain. More specifically, embodiments include the configuration of a system to obtain a plurality of entries from a first dataset, where each entry of the plurality of entries includes a first set of subentries having sensitive data, such as personally identifiable information (PII) associated with a user profile, and a second set of subentries having network operation data representing one or more network operations involving the user profile. The system can then generate, for each entry of the first dataset, a user identifier based on the second set of subentries and an encrypted representation of the second set of subentries. In some examples, the system can generate a second dataset to remove the second set of subentries based on generating the encrypted representation of the first set of subentries for each entry of the first dataset. The system can then provide, to a device (e.g., a remote server), the second dataset to cause the device to execute one or more operations based on the second dataset.

In some embodiments, the system can obtain, from the device, a third dataset including the second dataset and supplemental data associated with each entry of the second dataset. And in response to decrypting a portion of the third dataset, the system can generate an augmented dataset comprising the first set of subentries, the second set of subentries, and a third set of subentries comprising the supplemental data, the augmented dataset reestablishing the second set of subentries for each entry of the plurality of entries in association with the supplemental data. This method can allow for the protection of sensitive data during communication with external devices.

By virtue of the implementation of the techniques described herein, systems can be configured to encrypt portions of database rows at specific columns prior to communication in a way that achieves multiple technical benefits. First, systems can be configured as described to conserve computing resources by limiting the scope of encryption and decryption operations. By encrypting specific portions of each row, rather than entire tables or databases, the computational load on the processor can be reduced/conserved as fewer operations are executed. This can allow for the implementation of encryption only where it is desirable or necessary to do so. And systems can enhance security by ensuring that only authorized users or systems can access specific data fields, either by reading or decoding these data fields. By encrypting sensitive portions of columns at the row level, systems can implement fine-grained access control, allowing users or devices to manipulate only the data they are permitted to view. For instance, a database storing financial records could encrypt account balances at the row level, ensuring that only authorized systems can decrypt and view this information. Additionally, the original system that encrypted the data can re-identify the updated data through matching, enabling it to update the original file with new data added (e.g., appended) by a system of a third-party that receives the partially-encrypted data.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram of an environment for protecting portions of a dataset when communicating with devices outside of a domain, in accordance with one or more embodiments.

FIG. 2A shows an illustrative diagram of a process for encoding portions of a dataset when protecting portions of the dataset, in accordance with one or more embodiments.

FIG. 2B shows an illustrative diagram of a process for decoding portions of a dataset when protecting portions of the dataset, in accordance with one or more embodiments.

FIG. 3 shows illustrative components for a system used to protect portions of a dataset when communicating with devices outside of a domain, in accordance with one or more embodiments.

FIG. 4 shows a flowchart of the steps involved in a process for protecting portions of a dataset when communicating with devices outside of a domain, in accordance with one or more embodiments.

FIG. 5 shows an example diagram of a process for communicating with a device outside of a given domain, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention can be practiced without these specific details or with an equivalent arrangement. In other cases, well-known structures and devices are shown in block diagram form in order to avoid unnecessarily obscuring the embodiments of the invention.

The present disclosure describes systems and methods that are configured to protect portions of a dataset when communicating with devices outside of a domain. For example, initially, a plurality of entries can be obtained from a first dataset, where each entry includes a first set of subentries (e.g., associated with personally-identifiable information (“PII”)) and a second set of subentries (e.g., associated with other data that may not necessarily represent PII). For each entry, a user identifier (referred to as a universal unique identifier or UUID) can be generated based on the first set of subentries along with an encrypted representation of the second set of subentries (encrypted using a key managed by a key management system (KMS)). A second dataset can then be generated that removes the second set of subentries based on generating the user identifiers, where the second dataset includes the first set of subentries and corresponding user identifiers. This second dataset can then be provided to a device to execute one or more operations based on the second dataset. The device can return a third dataset comprising the second dataset and supplemental data associated with each entry of the second dataset. Finally, upon decrypting a portion of the third dataset, an augmented dataset can be generated, which includes the first set of subentries, the second set of subentries, and a third set of subentries comprising the supplemental data.

By implementing the described techniques, systems can be configured to encrypt specific portions of database rows (also referred to as dataframe rows) at designated columns, which can result in several technical benefits. First, targeted encryption can reduce the computational load on a system maintaining a given database by limiting encryption and decryption operations to data as part of workflows when communicating that data outside of the system’s domain (e.g., to systems controlled by third-parties), conserving processing and memory resources that would be consumed when encrypting the broader database. This can also allow for performance optimization and faster encryption and transmission of data (e.g., in response to a request for the data). Second, security can be enhanced as access is selectively restricted for specified data fields, enabling fine-grained access control without having to manage multiple datasets in parallel. For example, a database storing financial records can encrypt account balances or other indications of sensitive account activity at the row level, ensuring only authorized systems that receive this data can decrypt the data. Additionally, the original system can re-identify and update datasets with new information appended by third-party systems, maintaining data integrity.

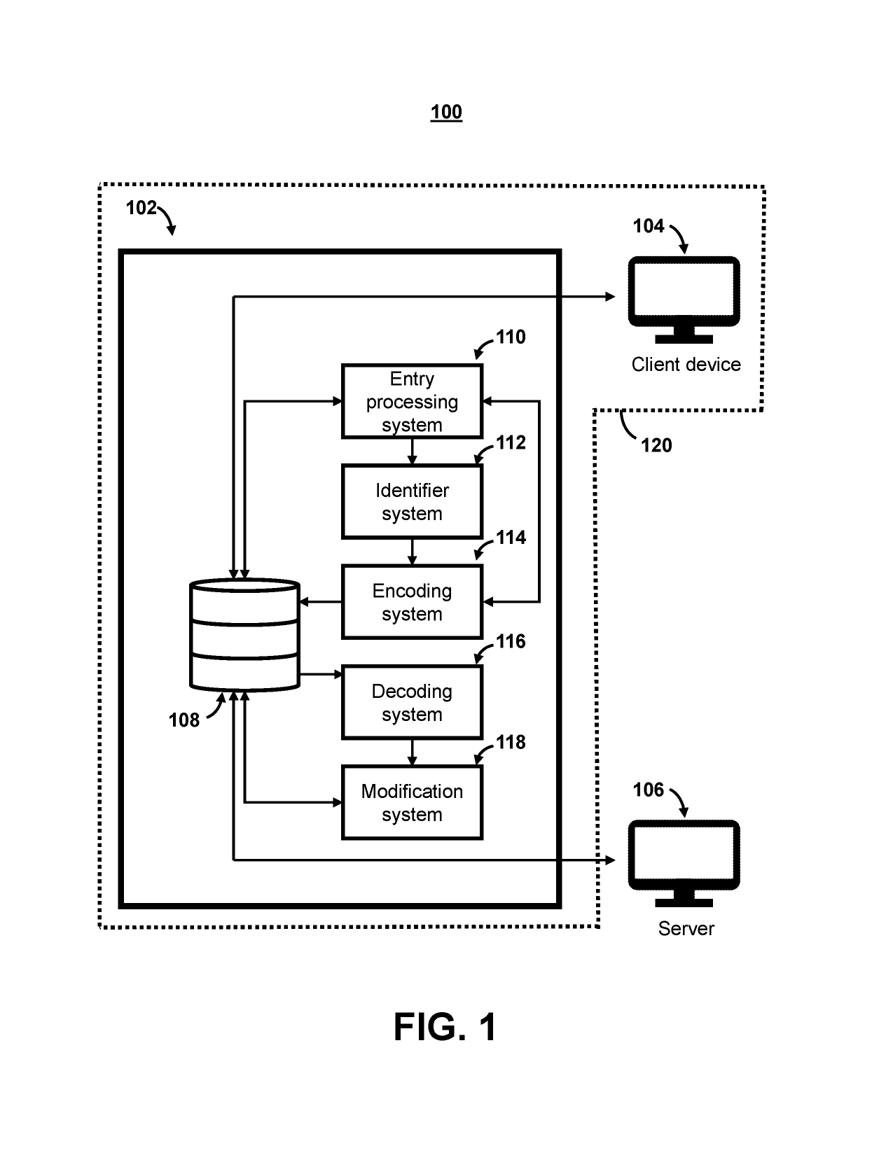

FIG. 1 shows a diagram of an environment 100 for protecting portions of a dataset when communicating with devices outside of a domain, in accordance with one or more embodiments. For example, an environment 100 can include a system 102, a client device 104, and a server 106. The system 102 (e.g., one or more components of the system 102 as described herein), the client device 104, and the server 106 can be configured to interconnect using one or more wired and/or wireless connections as described herein.

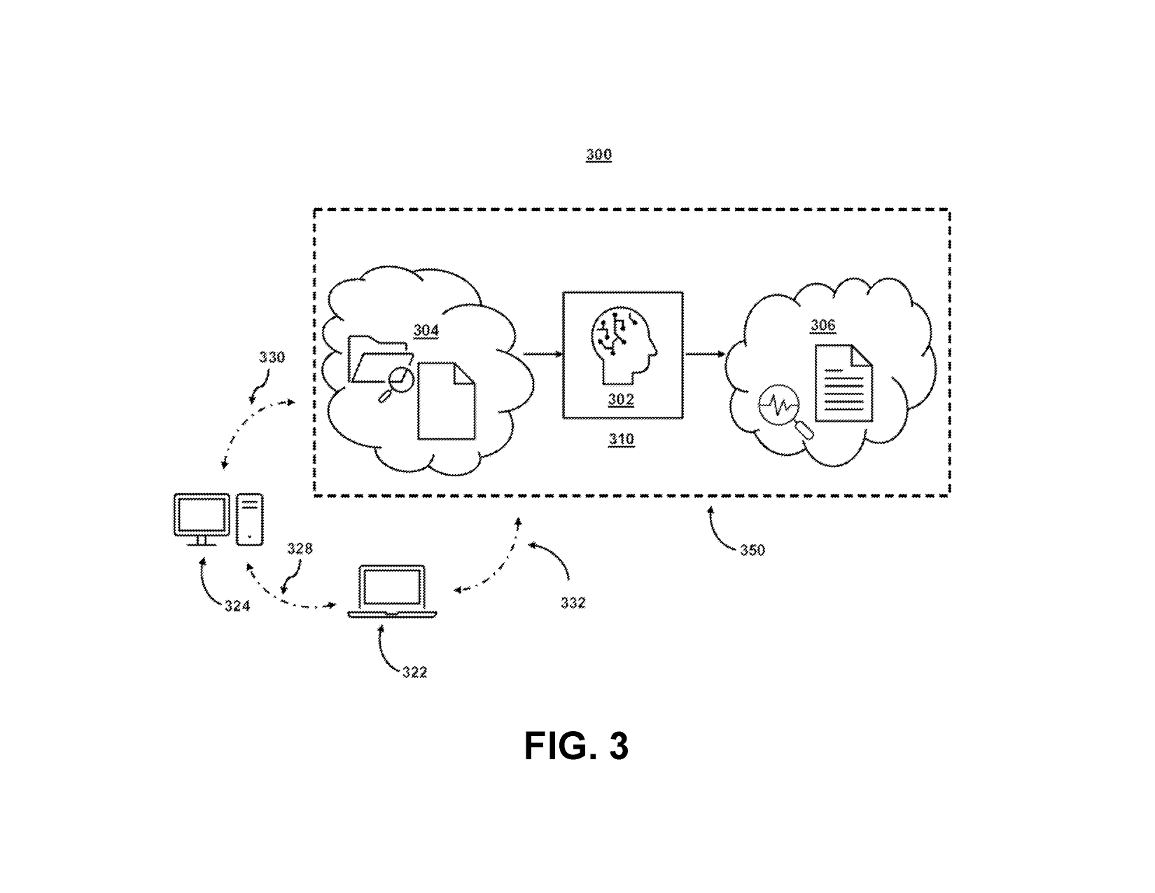

The system 102 can include a database 108 (e.g., configured to be compatible with a PySpark dataset, etc.), an entry processing system 110, an identifier system 112, an encoding system 114, a decoding system 116, and a modification system 118. However, in some examples, the system 102 can include and/or exclude one or more of the illustrated components. For example, the system 102 can include any combination of the database 108, the entry processing system 110, the identifier system 112, the encoding system 114, the decoding system 116, and/or the modification system 118. In some embodiments, the system 102 can include one or more components that are the same as, or similar to, the user terminal 324 of FIG. 3 and can configure those components to implement some or all of the functions described with respect to the database 108, the entry processing system 110, the identifier system 112, the encoding system 114 as described herein.

The components of the system 102 can be implemented as individual devices or can be collectively implemented by a single device or group of devices. For example, the database 108 can include one or more devices configured to be in communication with the entry processing system 110, the identifier system 112, the encoding system 114, the decoding system 116, and/or the modification system 118. In some examples, the database 108 can be configured to be in communication with the client device 104. In examples, the database 108 can be configured to be in communication with the server 106. In some embodiments, the database 108 can be implemented to obtain messages passed within a network that is the same as, or different from, the network 120 and established to allow for communication between one or more client devices (not explicitly illustrated) when executing one or more network operations.

The entry processing system 110 can include one or more devices configured to be in communication with the database 108 and/or the identifier system 112. For example, the entry processing system 110 can include a device such as, for example, a server, a virtual machine, etc. As described herein, the entry processing system 110 can be configured to receive a dataset representing user profiles associated with one or more individuals that control one or more user accounts. The entry processing system 110 can then be configured to execute one or more operations in coordination with the identifier system 112 and/or the encoding system 114 to obtain entries from a first dataset (e.g., maintained by the database 108) and process the entries to identify a first set of subentries and a second set of subentries.

The identifier system 112 can include one or more devices configured to be in communication with the entry processing system 110 and/or the encoding system 114. For example, the identifier system 112 can include a device such as, for example, a server, a virtual machine, etc. As described herein, the identifier system 112 can be configured to receive a dataset having multiple entries once processed by the entry processing system 110, where the entries represent user profiles that are associated with one or more individuals that control one or more user accounts. The identifier system 112 can then be configured to execute one or more operations in coordination with the identifier system 112 and/or the encoding system 114 to generate a user identifier for each entry of the first dataset using the second set of subentries identified by the identifier syst em 112.

The encoding system 114 can include one or more devices configured to be in communication with the identifier system and/or the database 108. For example, the encoding system 114 can include a device such as, for example, a server, a virtual machine, etc. As described herein, the encoding system can be configured to receive a dataset having multiple entries once processed by the identifier system 112, where the entries represent user profiles that are associated with one or more individuals that control one or more user accounts and, in some instances, user identifiers (UUIDs). The encoding system 114 can then be configured to execute one or more operations to encode portions of the dataset and store the results of the execution in the database 108 encrypted representations of the second set of subentries in each entry. These results can be stored as updates to the datasets or as additional datasets (e.g., a second dataset) that are mapped to the original datasets (e.g., the first dataset).

The decoding system 116 can include one or more devices configured to be in communication with the database 108 and/or the modification system 118. For example, the decoding system 116 can include a device such as, for example, a server, a virtual machine, etc. As described herein, the decoding system 116 can be configured to receive a dataset that is encoded, the dataset representing portions of user profiles associated with one or more individuals that control one or more user accounts and supplemental data added to the dataset by a device outside of the network 120, such as the server 106. The decoding system 116 can then be configured to execute one or more operations in coordination with the modification system 118 to decode portions of datasets (e.g., a third dataset) as described herein.

The modification system 118 can include one or more devices configured to be in communication with the decoding system 116 and/or the database 108. For example, the modification system 118 can include a device such as, for example, a server, a virtual machine, etc. As described herein, the modification system 118 can be configured to receive a dataset from the decoding system 116 based on (e.g., after) execution of operations by the decoding system 116 involved in decoding portions of the data stored in the database 108. The modification system 118 can then be configured to execute one or more operations to update the datasets (referred to as an augmented dataset once updated) stored in the database 108 with respective portions of the supplemental data (e.g., by adding new row(s) to the datasets) and/or add new datasets that can be mapped to one or more existing datasets in the database 108.

The client device 104 can include one or more devices configured to be in communication with the system 102 and/or one or more other client devices (not explicitly illustrated). For example, the client device 104 can include a device such as a mobile device (e.g., a cellular telephone, a tablet, etc.), a laptop computer, a desktop computer, a point-of-sale device, etc. In some embodiments, the client device 104 can be associated with one or more individuals or organizations. For example, the client devices 104 can be associated with one or more individuals or organizations involved in operations executed within payment processing network, merchants, one or more acquiring institutions, one or more issuing institutions, one or more customers, one or more service providers assisting in execution of network operations, etc. In some embodiments, the client device 104 can include one or more components that are the same as, or similar to, the mobile device 322 of FIG. 3.

In some embodiments, the devices of the environment 100 and/or the components of one or more of the devices can be configured to establish direct or indirect communication connections between one another. For example, one or more networks can establish communication paths between one or more of the devices of the environment 100 to allow for the communication of messages (e.g., network packets, etc.) therebetween. In this example, the communication paths can be the same as, or similar to, the communication paths 328, 330, and 332 of FIG. 3. The network(s) can include mobile phone networks, mobile voice or data networks, cable networks, public switched telephone networks, the Internet, or other types of communications networks or combinations of communications networks as described herein.

The network 120 can include, or be formed by or between, the system 102 and the client device 104. For example, the network 120 can establish communication connections between the devices therein to form a domain. In some embodiments, the network 120 can be established by a payment processor to process network operations (e.g., payment transactions). For example, the network 120 can be established by a payment processor to process network operations involving one or more different client devices (e.g., client devices that are controlled by participants in a given network operation such as customers, acquiring institutions, issuing institutions, etc.).

It will be understood that the number and arrangement of devices in the environment 100 are provided as an example and that there can be differently arranged environments than those shown in FIG. 1. In some embodiments, at least some of the devices and/or systems of FIG. 1 can be implemented by a single device or multiple devices within a distributed system. For example, the system 102 can be implemented by a single device or as multiple devices that either alone, or in coordination, perform one or more of the operations as described herein.

With continued reference to FIG. 1, one or more of the components of the environment 100 can be configured to execute operations to protect portions of a dataset when communicating with devices outside of a domain (e.g., the server 106). For example, initially, data can be received by the database 108 and stored as one or more entries and/or subentries (of respective entries) in one or more datasets of the database 108. The data can be received in response to execution of one or more operations by client devices (not explicitly illustrated) and subsequent communication between the client device 104 and the system 102. Each entry in the datasets stored by the database 108 can correspond to a particular individual (e.g., user, customer, etc.) and represent one or more aspects of network operations executed by, or otherwise involving, that particular individual. These aspects can include PII such as unique user identifiers associated with one or more organizations monitoring these individuals network operation activity, and non-PII, such as one or more attributes of the network operation activity itself (e.g., account balances, transaction amounts, aggregated transaction amounts over periods of time, average transaction amounts over periods of time, etc.), and so on. In some embodiments, the aspects corresponding to the individual or the network operations involving the individual can be separated into distinct portions based on their context. For example, the user identifier or identifiers of each individual can be associated with a first set of subentries in each entry corresponding to a given individual, where the information represented by the data in each of the subentries is associated with a first context (e.g., that the data includes PII). In this example the aspects representing the attributes of the network operation activity itself can be associated with a second set of subentries, where the information represented by the data in each of the subentries in the second set of subentries is associated with a second context (e.g., that the data includes information such non-PII).

In some embodiments, the system 102 can execute the entry processing system 110 to analyze one or more datasets maintained by the database 108. For example, the entry processing system 110 can analyze the entries of the one or more datasets and determine a context for each subentry of each entry in a given dataset. For example, the entry processing system 110 can be configured to receive a dataset from the database 108 and determine a context for sets of subentries for a given entry in the dataset. When doing so, the entry processing system 110 can determine the context for each subentry in a first and second set of subentries, where the context indicates whether the data of each subentry is associated with a first data type or a second data type. The first data type can be associated with data that is associated with PII, and the second data type can be associated with data that is not directly related to, or associated with, PII. The system 102 can then provide at least a portion of the dataset to the identifier system 112 and/or the encoding system 114 along with an indication for the identifier system 112 of the context of each of the subentries for each entry in the dataset.

In some environments, the system 102 can execute the identifier system 112 to generate one or more user identifiers for each entry in the one or more datasets. For example, the system 102 can execute the identifier system 112 by causing the entry processing system 110 to provide at least a portion of the dataset being analyzed along with indications of contexts for each of the subentries in the portions of the dataset received by the identifier system 112. In this example, the identifier system 112 can identify at least a subset of subentries from among the first set of subentries to be used when generating user identifiers. For example, the identifier system 112 can identify predetermined subentries such as first names, last names, unique user identifiers such as social security numbers, etc., or combinations thereof. The identifier system can then execute one or more operations to transform the subset of subentries into corresponding user identifiers (UUIDs). For example, the identifier system 112 can execute one or more operations that involve generating hash values based on the information represented by the subset of subentries to generate a unique user identifier for each individual represented by the entries of the dataset. The identifier system 112 can then provide at least a portion of the dataset to the encoding system 114 to cause the encoding system 114 to execute one or more operations as described herein. In some examples, it will be understood that the identifier system 112 can update one or more portions of the datasets maintained by the database 108 separate from, or in addition to, causing the encoding system 114 to execute the operations as described herein.

In some embodiments, the system 102 can execute the encoding system 114 by causing the entry processing system 110 and/or the identifier system 112 to provide at least a portion of the dataset being analyzed along with corresponding user identifiers included in (e.g., added to) each entry of the dataset. In this example, the encoding system 114 can identify at least a subset of subentries from among the second set of subentries for each entry in the dataset and execute one or more operations to transform the data in those subentries. For example, the encoding system 114 can execute one or more operations to encrypt the identified subset of subentries and generate an encrypted representation of those subentries. The encoding system 114 can then update the dataset obtained by the encoding system 114 and provide the updated dataset to the database 108 to be stored and later provided to the server 106. In some examples the encoding system can use the dataset updated by the encoding system 114 to generate one or more updates to the dataset originally received by the entry processing system 110 and maintained by the database 108. In examples, the encoding system 114 can provide the dataset for storage in the database 108 and map the dataset to the dataset originally received by the entry processing system 110. The terms encode and encrypt should be understood to refer to the execution of similar operations, where contextually appropriate.

To encode portions of the datasets, the encoding system 114 can execute one or more operations to encrypt the identified subsets of subentries described above by first concatenating each subentry of the identified subset of subentries to generate concatenated data. In some examples, the encoding system 114 can then update the concatenated data by converting the values represented by the concatenated data, such as text characters, etc., into a binary representation. This conversion can involve executing operations to compress a given text string corresponding to concatenated subentries by first converting the concatenated subentries into a sequence of bytes. In some examples, the conversion can then involve compressing the sequence of bytes using a compression algorithm (e.g., a lossless compression algorithm). This compression can involve identifying repeating patterns in the byte sequence, replacing them with shorter codes, and producing a compressed version of the original input. The result can include a binary, non-human-readable compressed byte sequence that is smaller than the original, particularly for longer texts with repetitive content. In some embodiments, the encoding system 114 can encode the data at any point of the process described above and generate a compact representation of the subsets of subentries (also referred to as an encoded representation of the second set of subentries).

In some embodiments, the system 102 can be configured to provide data to the server 106 in response to receiving or otherwise obtaining a request to provide data to a server 106. For example, the system 102 can receive the request based one the system 102 obtaining or more messages from the server 106 via a communication connection between the system 102 and the server 106. In some examples, the request can include authentication credentials or encryption keys to ensure secure communication between the system 102 and the server 106, allowing the system 102 to encrypt the data to be provided to the server 106. Upon receiving the request, the system 102 can process the request and return a response. The response can include a third dataset that includes data associated with an encrypted portion of a dataset (the encrypted non-PII) and supplemental data (e.g., data that was generated by the server 106 based at least in part on the data received by the server 106 from the system 102).

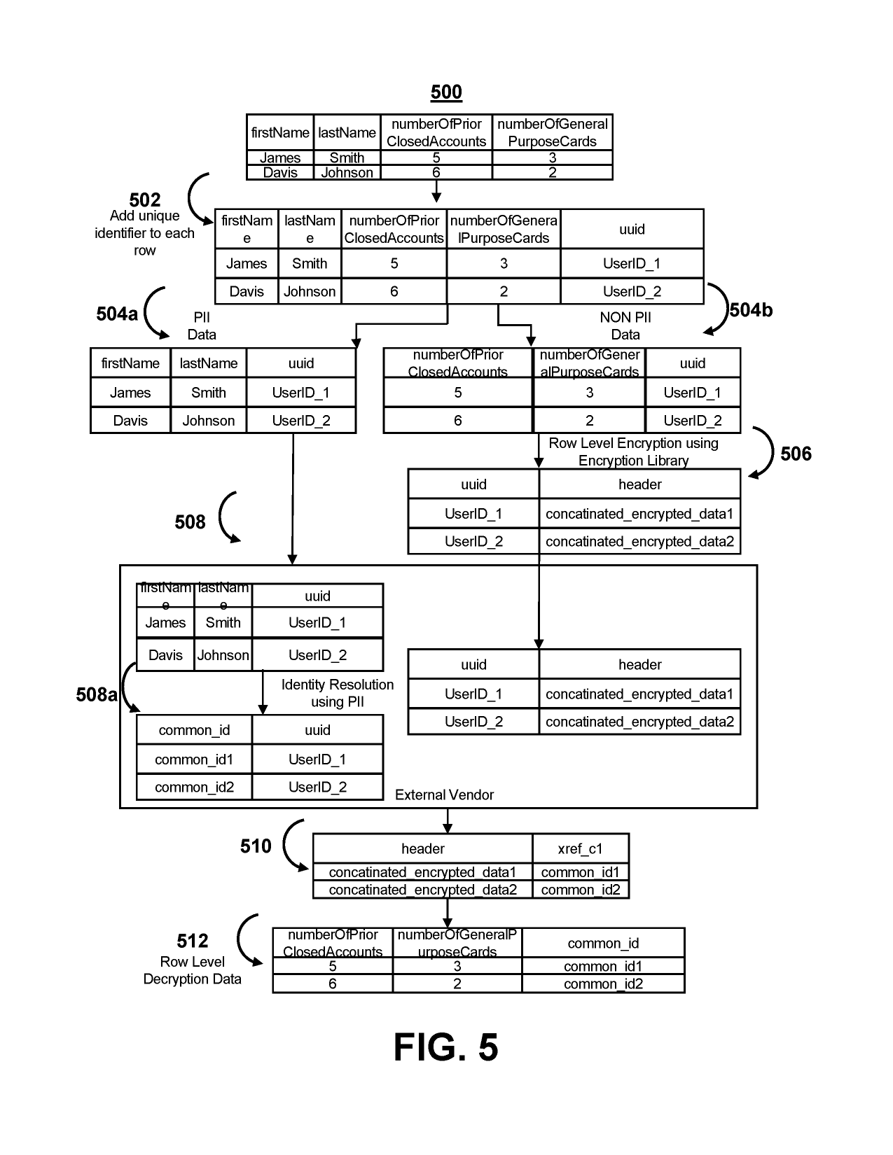

In some examples, the response from server 106 can include a portion of the dataset along with supplemental data structured as additional rows to be integrated into the dataset. For example, the server 106 can obtain the data from the system 102 and generate a common identifier (shown in FIG. 5 as a “common_id1, common_id2”). The system 102 can then decrypt this encrypted portion using a predefined decryption key and algorithm. The supplemental data, which can include metadata or context-specific information, can be parsed by the system 102 and appended to the existing dataset(s) maintained by the database 108. In some examples, this supplemental data can be used by the system 102 to resolve the identity of the user when adding portions of the supplemental data to respective rows of the datasets maintained by the database 108. The system 102 can then process the supplemental data by matching it against the existing data maintained in the database 108 or by executing predefined algorithms to identify unique attributes associated with the user. Once the identity is resolved, system 102 can dynamically update datasets maintained by the database 108 as described herein to append (e.g., include) portions of the supplemental data to respective entries of one or more datasets maintained by the database 108.

In some embodiments, the system 102 can execute the decoding system 116 to decode the data included in the response from the server 106. For example, the decoding system 116 can be configured to obtain the data associated with the response from the server 106 from the database 108. In this example, the decoding system 116 can decode the data associated with the response. Once decoded, the decoding system 116 can extract the supplemental data and execute the modification system 118 to add portions of the supplemental data (associated with a third set of subentries) to corresponding entries of the dataset maintained by the database 108.

In some embodiments, the decoding system 116 can decode the data obtained from the database 108 by decrypting the data and extracting the supplemental data from the data included in the response from the server 106. This can involve the decoding system 116 executing cryptographic techniques to convert encrypted data into the form it was represented in before encryption by the encoding system 114. In some embodiments the decoding system 116 can then decompress the portion of the third dataset to generate a representation of the concatenated data included in the third dataset. In examples, this process can involve reading and decompressing data archives to retrieve a continuous stream of bytes based on predefined compression algorithms. The decoding system 116 can then parse the concatenated data that was decompressed to generate a second set of subentries and a third set of subentries (e.g., the supplemental data). In some examples, the parsing operation can involve examining the structure of the concatenated data and applying string manipulation techniques based on known delimiters or data constructs established by the dataset originally processed by the entry processing system 110. In this example, the decoding system 116 can extract discrete data segments that are organized into corresponding subsets. The corresponding subsets can then be used by the modification system 118 to update the dataset(s) maintained by the database 108.

In some embodiments, the system 102 can execute the modification system 118 to update one or more datasets stored by the database 108 with the supplemental data. For example, the system 102 can execute the modification system 118 by causing the decoding system 116 to provide at least a portion of the response that was decoded to the modification system 118. The modification system 118 can then analyze the data obtained from the decoding system 116 to determine a correlation between portions of the supplemental data and the entries in the dataset(s) maintained by the database 108. In some embodiments, the modification system 118 can then update the dataset(s) maintained in the database 108 by appending subentries (referred to as a third set of subentries) represented by the supplemental data to corresponding entries in the dataset(s) maintained by the database 108.

In some embodiments, to separate the second set of subentries from the third set of subentries after decoding the data obtained from the database 108, the modification system 118 can compare the second set of subentries and the third set of subentries to the first dataset to identify the third set of subentries. For example, the modification system 118 can execute a systematic comparison using pattern matching or numerical evaluation based on metrics defined in the first dataset. In this example, the determination of the third set of subentries is achieved by isolating those elements that match specific criteria derived from the first dataset. In other examples, the modification system 118 can implement the semantic comparison to identify the subentries of the second set of subentries that correspond with headers established by the datasets maintained by the database 108. The modification system 118 can then determine the third set of subentries (those that do not correspond with headers established by the datasets maintained by the database 108) and update the datasets by matching the respective subentries with entries in the datasets of the database 108.

In some embodiments, the modification system 118 can determine that one or more aspects of the portion of the first dataset maintained by the database 108 match one or more aspects of the third dataset obtained as the response from the server 106. For example, the modification system 118 can implement data matching techniques such as deterministic matching methods to establish matches are between fields of the first dataset and the third dataset. In other examples, probabilistic matching can be implemented to account for variations in data attributes.

In some embodiments, the modification system 118 can validate the third dataset based on the one or more aspects of the portion of the first dataset matching the one or more aspects of the third dataset. For example, the modification system 118 can implement rule-based validation to confirm that matched data complies with predefined rules, headers, etc., of the datasets maintained by the database 108. These validation steps can include cross-field checks, database constraints, or pattern match analysis.

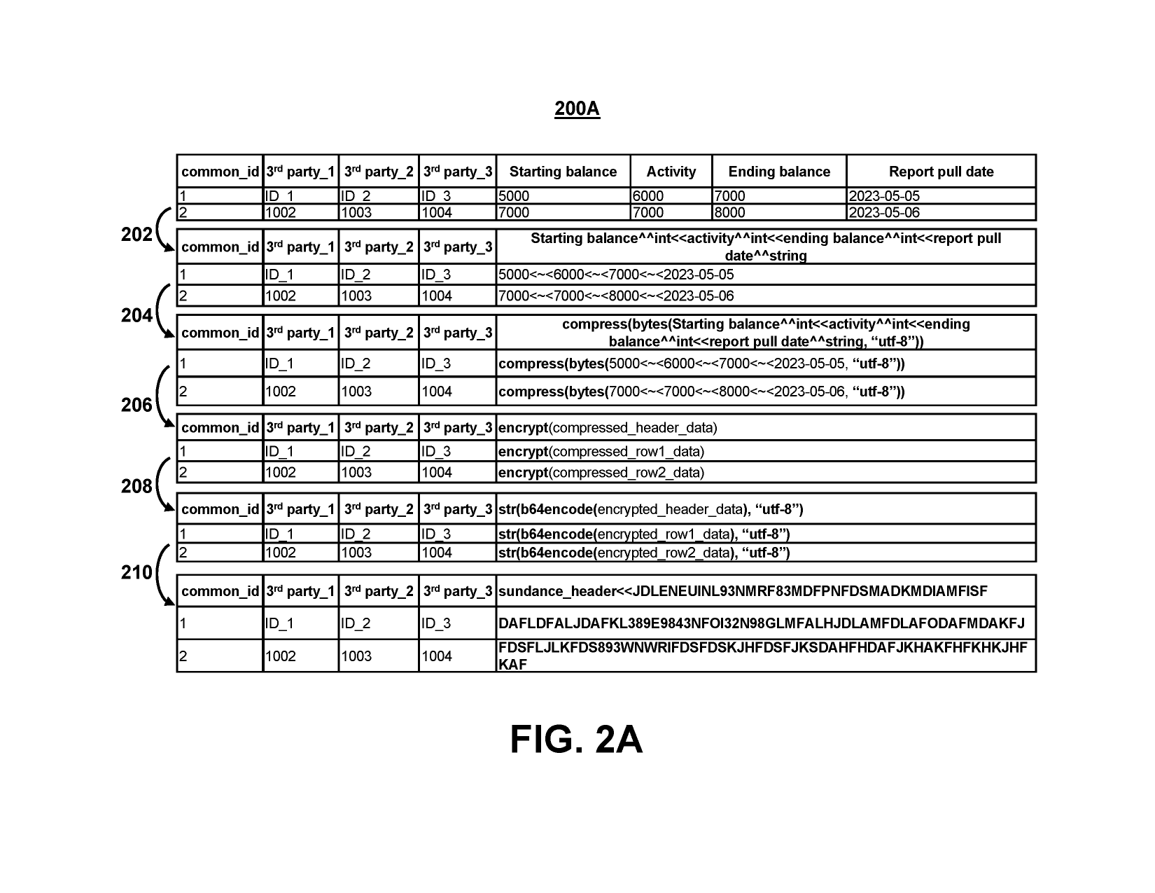

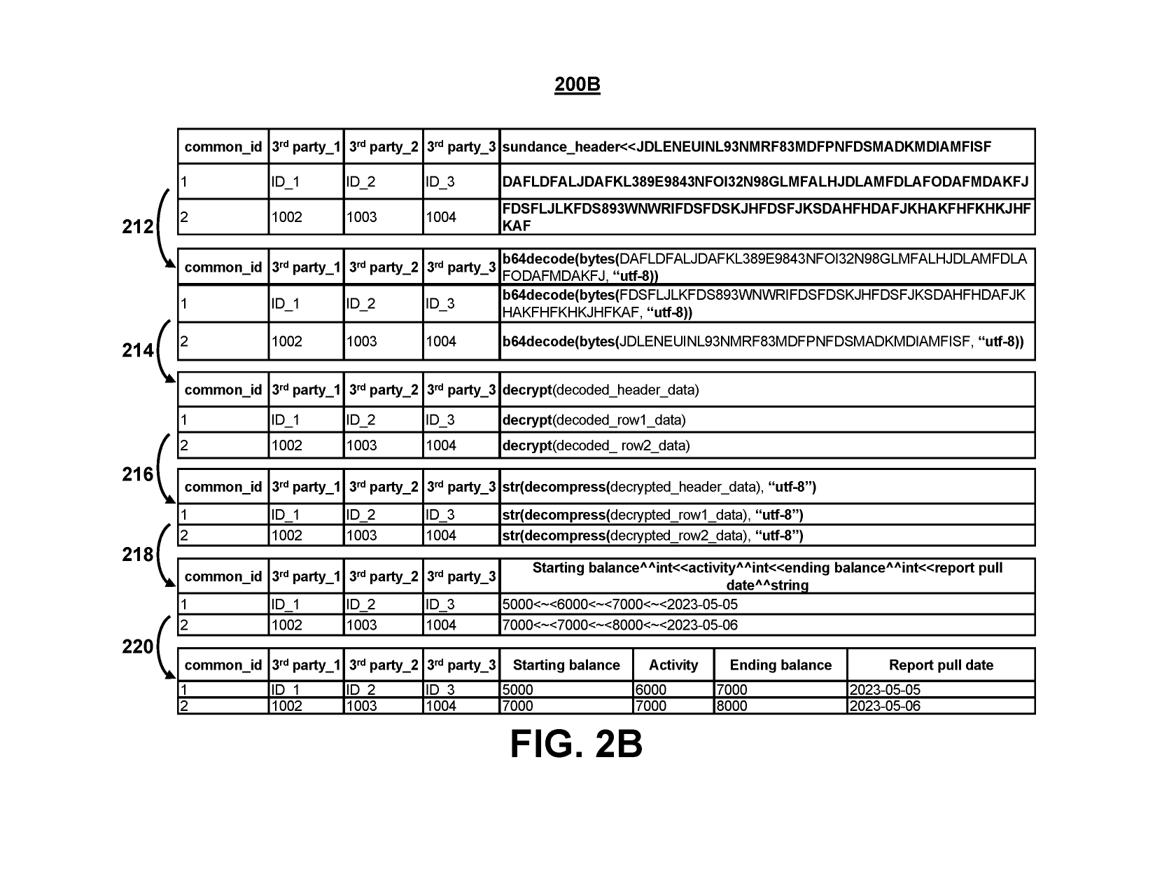

FIG. 2A shows an illustrative diagram of a process 200A for encoding portions of a dataset when protecting portions of the dataset, in accordance with one or more embodiments. In some embodiments, one or more of the operations described with respect to process 200A can be executed by one or more devices that are the same as, or similar to, those described with respect to FIG. 1.

At operation 202, a system (e.g., that is the same as, or similar to, the system 102 of FIG. 1) can concatenate one or more subentries of a second subset of entries in a dataset (e.g., that is maintained by the system in a database that is the same as, or similar to, the database 108 of FIG. 1). For example, the system determines a first set of subentries, and a second set of subentries based on headers that are associated with the dataset. The system can then extract and identify the individual subentries from the second set of subentries within a dataset and combine them into a single concatenated sequence. In some examples, these subentries can be combined using concatenation functions that preserve the original order and context of each subentry.

At operation 204, the system can transform the concatenated data into a series of bytes by applying an encoding scheme such as UTF-8. The system can then compress the byte stream. In some examples, this conversion allows the system to work with binary representations that are more efficient for storage and transmission, while compression algorithms allow for the reduction of the size of the data without loss of information attributable to the compression.

At operation 206, the system can encrypt series of bytes using one or more encryption algorithms. For example, the system can implement symmetric encryption such as AES to convert the byte stream that was compressed into a ciphertext that protects the data from unauthorized access while allowing for later decryption.

At operation 208, the system can encode the encoded version of the series of bytes into a string format to allow for compatibility with systems that handle textual data rather than raw bytes. In some examples, the system can apply encoding methods such as Base64 to the series of bytes, translating the binary data into a string that can be stored or transmitted using text-based protocols.

At operation 210, the system can replace the original subentries of the second set of subentries with the resulting string that represents the encoded series of bytes. In some examples, the system can implement this replacement by executing one or more update or replace functions within the dataset. In examples, the system can then communicate the updated dataset (also referred to throughout as a second dataset) to other systems that are outside of a domain associated with the transmitting system.

FIG. 2B shows an illustrative diagram of a process 200B for decoding portions of a dataset when protecting portions of the dataset, in accordance with one or more embodiments. In some embodiments, one or more of the operations described with respect to process 200B can be executed by one or more devices that are the same as, or similar to, those described with respect to FIGS. 1 and/or 2A.

At operation 212, after receiving data from a remote system, a system (e.g., that is the same as, or similar to, the system 102 of FIG. 1) can process the data to identify the string representing the encoded series of bytes and initiate a decoding process to revert the encoded series of bytes back into its prior binary form. The system can then decode the series of bytes using a decoding method such as Base64. In some examples, this decoding process can transform the string representation into a binary format that, at least in part, matches the encrypted byte stream produced during the earlier encoding stage.

At operation 214, the system can decrypt the series of bytes to recover the compressed byte stream. To do so, the system can implement one or more decryption algorithms as described herein using the same encryption key that was used during encryption to restore the original compressed data while maintaining data integrity.

At operation 216, the system can decompress the decrypted data. For example, the system can decompress the data to expand the compressed byte stream back into its original concatenated form. In some examples, decompression algorithms can be used to reverse the compression applied.

At operation 218, the system can separate and extract individual subentries from the concatenated data to reconstruct the original second set of subentries within the dataset. In some examples, predefined delimiters or markers embedded during concatenation can be used to identify boundaries between subentries. In examples, this final step can be implemented to validate and/or confirm that each subentry is accurately restored to its original position and format within the dataset. In other examples, the system can parse the subentries to determine the second set of subentries and a third set of subentries. This third set of subentries can then be used by the system to augment one or more datasets maintained in a database associated with the system.

FIG. 3 shows illustrative components for a system used to protect portions of a dataset when communicating with devices outside of a domain, in accordance with one or more embodiments. For example, FIG. 3 can show illustrative components for one or more autonomous models in a multi-autonomous model architecture. As shown in FIG. 3, system 300 can include mobile device 322 and user terminal 324. While shown as a smartphone and personal computer, respectively, in FIG. 3, it should be noted that mobile device 322 and user terminal 324 can be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 can alternatively be any computing device as described above, and can include any type of mobile terminal, fixed terminal, or other device. For example, cloud components 310 can be implemented as a cloud computing system and can feature one or more component devices. It should also be noted that system 300 is not limited to three devices. Users can, for instance, utilize one or more devices to interact with one another, one or more servers, or other components of system 300. It should be noted, that, while one or more operations are described herein as being performed by particular components of system 300, these operations can, in some embodiments, be performed by other components of system 300. As an example, while one or more operations are described herein as being performed by components of mobile device 322, these operations can, in some embodiments, be performed by components of cloud components 310. In some embodiments, the various computers and systems described herein can include one or more computing devices that are programmed to perform the described functions. Additionally, or alternatively, multiple users can interact with system 300 and/or one or more components of system 300. For example, in one embodiment, a first user and a second user can interact with system 300 using two different components.

With respect to the components of mobile device 322, user terminal 324, and cloud components 310, each of these devices can receive content and data via input/output (hereinafter “I/O”) paths. Each of these devices can also include processors and/or control circuitry to send and receive commands, requests, and other suitable data using the I/O paths. The control circuitry can comprise any suitable processing, storage, and/or input/output circuitry. Each of these devices can also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices can have neither user input interfaces nor displays, and can instead receive and display content using another device (e.g., a dedicated display device such as a computer screen, and/or a dedicated input device such as a remote control, mouse, voice input, etc.). Additionally, the devices in system 300 can run an application (or another suitable program). The application can cause the processors and/or control circuitry to perform operations related to generating dynamic conversational replies, queries, and/or notifications.

Each of these devices can also include electronic storages. The electronic storages can include non-transitory storage media that electronically stores information. The electronic storage media of the electronic storages can include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages can include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages can include one or more virtual storage resources (e.g., cloud storage, a virtual private network, and/or other virtual storage resources). The electronic storages can store software algorithms, information determined by the processors, information obtained from servers, information obtained from client devices, or other information that enables the functionality as described herein.

FIG. 3 also includes communication paths 328, 330, and 332. Communication paths 328, 330, and 332 can include the Internet, a mobile phone network, a mobile voice or data network (e.g., a 5G or LTE network), a cable network, a public switched telephone network, or other types of communications networks or combinations of communications networks. Communication paths 328, 330, and 332 can separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices can include additional communication paths linking a plurality of hardware, software, and/or firmware components operating together. For example, the computing devices can be implemented by a cloud of computing platforms operating together as the computing devices.

Cloud components 310 can include model 302, which can be a machine learning model, artificial intelligence model, etc. (which can be referred collectively as “models” herein). Model 302 can take inputs 304 and provide outputs 306. The inputs can include multiple datasets, such as a training dataset and a test dataset. Each of the plurality of datasets (e.g., inputs 304) can include data subsets related to user data, predicted forecasts and/or errors, and/or actual forecasts and/or errors. In some embodiments, outputs 306 can be fed back to model 302 as input to train the model 302 (e.g., alone or in conjunction with user indications of the accuracy of outputs 306, labels associated with the inputs, or with other reference feedback information). For example, the system can receive a first labeled feature input, wherein the first labeled feature input is labeled with a known prediction for the first labeled feature input. The system can then train the first machine learning model to classify the first labeled feature input with the known prediction (e.g., an action graph, a graph characteristic, a graph value, an objective, etc.).

In a variety of embodiments, model 302 can update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights can be adjusted to reconcile differences between the neural network’s prediction and reference feedback. In a further use case, one or more neurons (or nodes) of the neural network can require that their respective errors be sent backward through the neural network to facilitate the update process (e.g., backpropagation of error). Updates to the connection weights can, for example, be reflective of the magnitude of error propagated backward after a forward pass has been completed. In this way, for example, the model 302 can be trained to generate better predictions.

In some embodiments, model 302 can include an artificial neural network. In such embodiments, model 302 can include an input layer and one or more hidden layers. Each neural unit of model 302 can be connected with many other neural units of model 302. Such connections can be enforcing or inhibitory in their effect on the activation state of connected neural units. In some embodiments, each individual neural unit can have a summation function that combines the values of all of its inputs. In some embodiments, each connection (or the neural unit itself) can have a threshold function such that the signal must surpass it before it propagates to other neural units. Model 302 can be self-learning and trained, rather than explicitly programmed, and can perform significantly better in certain areas of problem solving, as compared to traditional computer programs. During training, an output layer of model 302 can correspond to a classification of model 302, and an input known to correspond to that classification can be input into an input layer of model 302 during training. During testing, an input without a known classification can be input into the input layer, and a determined classification can be output.

In some embodiments, model 302 can include multiple layers (e.g., where a signal path traverses from front layers to back layers). In some embodiments, back propagation techniques can be utilized by model 302 where forward stimulation is used to reset weights on the “front” neural units. In some embodiments, stimulation and inhibition for model 302 can be more free-flowing, with connections interacting in a more chaotic and complex fashion. During testing, an output layer of model 302 can indicate whether or not a given input corresponds to a classification of model 302 (e.g., an action graph, a graph characteristic, a graph value, an objective, etc.).

In some embodiments, the model (e.g., model 302) can automatically perform actions based on outputs 306. In some embodiments, the model (e.g., model 302) cannot perform any actions. The output of the model (e.g., model 302) can be used to generate a response in a user interface.

System 300 also includes API layer 350. API layer 350 can allow the system to generate summaries across different devices. In some embodiments, API layer 350 can be implemented on mobile device 322 or user terminal 324. Alternatively, or additionally, API layer 350 can reside on one or more of cloud components 310. API layer 350 (which can be a REST or Web services API layer) can provide a decoupled interface to data and/or functionality of one or more applications. API layer 350 can provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 can use various architectural arrangements. For example, system 300 can be partially based on API layer 350, such that there is strong adoption of SOAP and RESTful Web services, using resources like Service Repository and Developer Portal, but with low governance, standardization, and separation of concerns. Alternatively, system 300 can be fully based on API layer 350, such that separation of concerns between layers like API layer 350, services, and applications are in place.

In some embodiments, the system architecture can use a microservice approach. Such systems can use two types of layers: Front-End Layer and Back-End Layer where microservices reside. In this kind of architecture, the role of the API layer 350 can provide integration between Front-End and Back-End. In such cases, API layer 350 can use RESTful APIs (exposition to front-end or even communication between microservices). API layer 350 can use AMQP (e.g., Kafka, RabbitMQ, etc.). API layer 350 can use incipient usage of new communications protocols such as gRPC, Thrift, etc.

In some embodiments, the system architecture can use an open API approach. In such cases, API layer 350 can use commercial or open-source API Platforms and their modules. API layer 350 can use a developer portal. API layer 350 can use strong security constraints by applying WAF and DDoS protection, and API layer 350 can use RESTful APIs as standard for external integration.

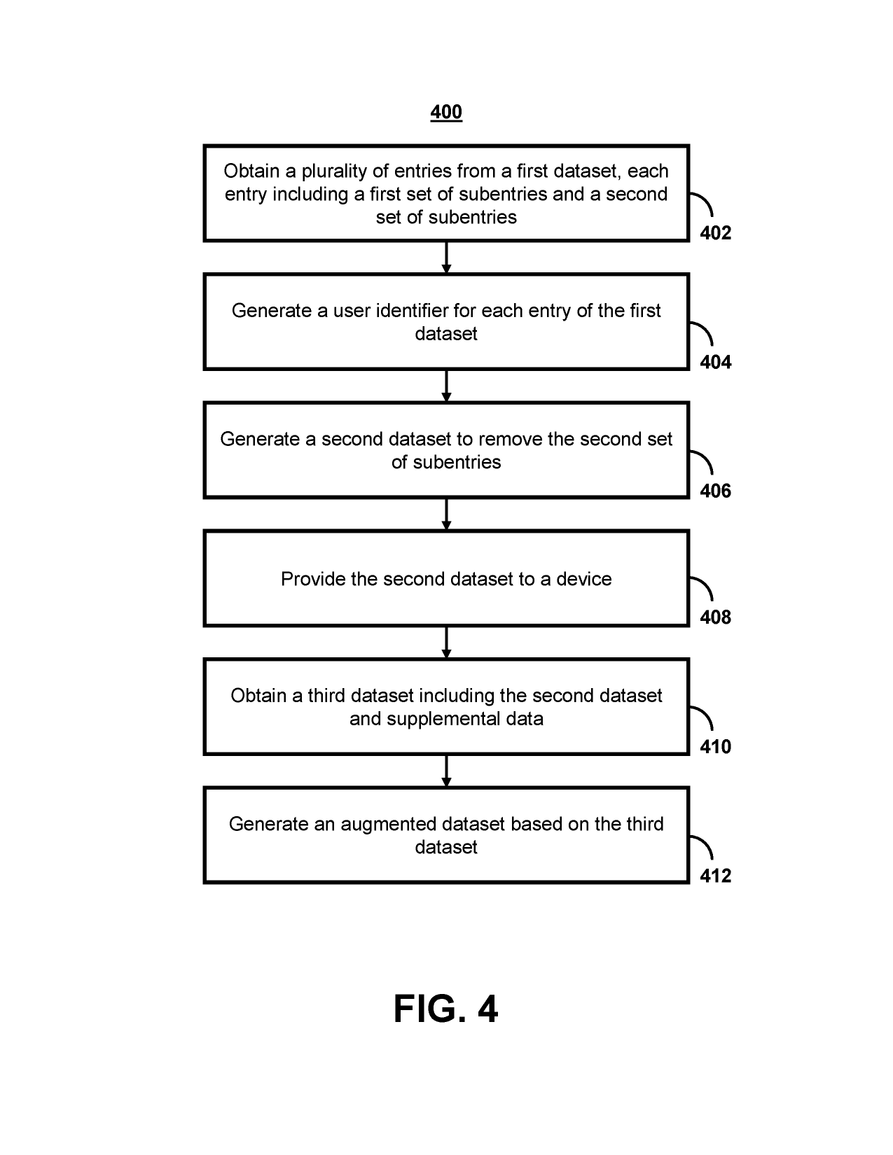

FIG. 4 shows a flowchart of the steps involved in a process 400 for protecting portions of a dataset when communicating with devices outside of a domain, in accordance with one or more embodiments. For example, a system that is the same as (or similar to) the system 102 of FIG. 1 (or one or more components thereof), can implement process 400.

At operation 402, the process 400 can include obtaining a plurality of entries from a first dataset. For example, the system can obtain the plurality of entries form the first dataset, where each entry of the plurality of entries includes a first set of subentries and a second set of subentries. In this example, the first dataset can include various types of data entries, each containing multiple subentries categorized into two distinct sets.

At operation 404, the process 400 can include generating a user identifier for each entry of the first dataset based on the second set of subentries and an encrypted representation of the second set of subentries. In this example, the user identifier can be created using specific subentries from the second set, along with an encrypted version of these subentries to ensure data security.

At operation 406, the process 400 can include generating a second dataset to remove the second set of subentries based on generating the encrypted representation of the first set of subentries for each entry of the first dataset. In this example, the second dataset can be created by excluding the second set of subentries and incorporating an encrypted version of the first set of subentries.

At operation 408, the process 400 can include providing the second dataset to a device to cause the device to execute one or more operations based on the second dataset. In this example, the device can perform specific tasks or processes using the information contained in the second dataset.

At operation 410, the process 400 can include obtaining a third dataset from the device, the third dataset including the second dataset and supplemental data associated with each entry of the second dataset. In this example, the third dataset can include additional information or data points related to each entry from the second dataset, gathered by the device.

At operation 412, the process 400 can include generating an augmented dataset. For example, the system can, in response to decrypting a portion of the third dataset, generate an augmented dataset including the first set of subentries, the second set of subentries, and a third set of subentries comprising the supplemental data. In this example, the system can generate the augmented dataset based on decrypting part of the third dataset and combining the original subentries with the newly obtained supplemental data.

FIG. 5 shows an example diagram of a process 500 for communicating with a device outside of a given domain, in accordance with one or more embodiments. For example, a system that is the same as (or similar to) the system 102 of FIG. 1 (or one or more components thereof), can implement portions or all of the process 500. It will be understood that one or more operations described can be the same as, or similar to, the operations described with respect to the operations described as being performed by the devices of the environment 100 of FIG. 1 and/or the process 400 of FIG. 4.

In some embodiments, at operation 502, the system can determine a user identifier that is unique for each entry based on at least a portion of a second subset of subentries for each entry in the dataset (e.g., the subentries corresponding to a number of prior closed accounts “numberOfPriorClosedAccounts” and/or a number of general purpose cards “nuberOfGeneralPurposeCards”). In this example, the unique user identifier can be generated by analyzing specific subentries within the dataset. In some examples, the system can use various algorithms to ensure the uniqueness of the identifier.

In some embodiments, at operation 504a, the system can correlate the unique user identifier with one or more subentries of the first set of subentries corresponding to personally identifiable information (as a first sub-dataset) (e.g., the subentries corresponding to the first name “firstName” and/or second name “secondName” of the individual associated with each entry). In this example, the correlation can help in identifying and linking the unique user identifier with personal information. In some examples, this process can enhance the accuracy of user identification.

In some embodiments, at operation 504b, the system can correlate the unique user identifier with the one or more subentries of the second set of subentries used to generate the unique user identifier (as a second sub-dataset). In this example, the correlation can allow the unique user identifier to accurately link to the subentries used in its generation and later be used to reestablish the identity of a user.

In some embodiments, at operation 506, the system can encrypt the one or more subentries of the second set of subentries used to generate the unique user identifier. In this example, encryption can provide an additional layer of security for the subentries. In some examples, various encryption techniques can be employed to protect the data as described herein.

In some embodiments, at operation 508, the system can provide the first sub-dataset and/or the second sub-dataset to a server controlled by a third party outside of a domain associated with the system. In this example, the transfer of datasets can allow for external processing or analysis of at least portions of the entries of the datasets. In some examples, secure transfer protocols can also be implemented to allow for improved data integrity.

In some embodiments, at operation 508a, the system can generate one or more common identifiers (“common_id”) based on the one or more entries of the first set of subentries to generate system-specific user identifiers. In this example, common identifiers can be used to standardize user identification across the two systems.

In some embodiments, at operation 510, the system can obtain the common identifiers and/or data associated with the common identifiers from the system outside of the domain. In this example, the system can use the common identifiers to integrate data generated by the system outside of the domain into the dataset(s) maintained by the system in the domain.

In some embodiments, at operation 512, the system can establish a correlation between the second set of subentries used to generate the unique user identifier and the common identifiers where the data associated with the common identifiers is provided in response from the system outside of the domain. In this example, the correlation can allow the system in the domain to reestablish the identity of the individuals as represented by the data stored in the datasets and augment the datasets.

The above-described embodiments of the present disclosure are presented for purposes of illustration and not of limitation, and the present disclosure is limited only by the claims which follow. Furthermore, it should be noted that the features and limitations described in any one embodiment can be applied to any embodiment herein, and flowcharts or examples relating to one embodiment can be combined with any other embodiment in a suitable manner, done in different orders, or done in parallel. In addition, the systems and methods described herein can be performed in real time. It should also be noted that the systems and/or methods described above can be applied to, or used in accordance with, other systems and/or methods.

An Application-Specific Integrated Circuit (ASIC) is a specialized hardware chip designed to perform a specific task or set of tasks with high efficiency. Unlike general-purpose processors, such as CPUs or GPUs, ASICs are custom-built for particular applications, optimizing performance, power consumption, and area efficiency. ASICs are widely used in areas such as cryptocurrency mining, telecommunications, and artificial intelligence (AI), where dedicated hardware can provide significant advantages over more flexible but less efficient alternatives. Implementing a large AI model in an ASIC requires designing custom circuits that accelerate the model’s computations while ensuring efficient memory management and data movement. Because AI models, particularly deep learning networks, involve extensive matrix multiplications and tensor operations, specialized hardware units such as systolic arrays or tensor processing units (TPUs) can be integrated to optimize these operations. To overcome this challenge, the system may use weight quantization, memory hierarchy optimization, and on-chip interconnects can be employed to improve throughput and reduce power consumption. To accommodate large models, the system may integrate high-bandwidth memory (HBM) or leverage chiplet architectures, where multiple ASICs work together in a modular fashion to process different portions of the model. Training AI models on an ASIC presents significant challenges since training involves dynamic weight updates and high computational flexibility, which contrasts with the fixed nature of ASICs. To do so, the system may use field-programmable gate arrays (FPGAs) or GPUs during the training phase, then transfer the trained model weights to the ASIC for inference. Alternatively, the system may design ASICs that support on-chip fine-tuning or low-bit precision training, allowing for limited retraining directly on the device. Additionally, co-designing hardware and algorithms ensures that the model architecture is tailored to the ASIC’s capabilities, reducing inefficiencies, and maximizing performance. By integrating specialized training accelerators, approximate computing methods, and efficient dataflow architectures, ASICs can be optimized for both training and inference, enabling large AI models to operate with minimal energy and latency constraints.

The present techniques will be better understood with reference to the following enumerated embodiments:
1. Methods for protecting portions of a dataset when communicating with devices outside of a domain.
2. The method of any one of the preceding embodiments, further comprising: obtaining a plurality of entries from a first dataset, where each entry of the plurality of entries comprises a first set of subentries and a second set of subentries; generating, for each entry of the first dataset, a user identifier based on the second set of subentries and an encrypted representation of the second set of subentries; generating a second dataset to remove the second set of subentries based on generating the encrypted representation of the first set of subentries for each entry of the first dataset; providing, to a device, the second dataset to cause the device to execute one or more operations based on the second dataset; obtaining, from the device, a third dataset comprising the second dataset and supplemental data associated with each entry of the second dataset; and in response to decrypting a portion of the third dataset, generating an augmented dataset comprising the first set of subentries, the second set of subentries, and a third set of subentries comprising the supplemental data.
3. The method of any one of the preceding embodiments, further comprising: for each entry of the first dataset, determining a context for each subentry of the first set of subentries and the second set of subentries, the context indicating that data of each subentry is associated with a first data type or a second data type; and determining the first set of subentries and the second set of subentries based on the context for each subentry.
4. The method of any one of the preceding embodiments, wherein generating, for each entry of the first dataset, the user identifier comprises: identifying at least a subset of subentries from among the first set of subentries; and executing one or more operations to transform the subset of subentries into the user identifier.
5. The method of any one of the preceding embodiments, wherein generating, for each entry of the first dataset, the encrypted representation of the second set of subentries comprises: identifying at least a subset of subentries from among the second set of subentries; and executing one or more operations to transform the subset of subentries into the encrypted representation of the second set of subentries.
6. The method of any one of the preceding embodiments, wherein executing the one or more operations to transform the subset of subentries comprises: concatenating each entry subentry of the second set of subentries to generate concatenated data; and encrypting the concatenated data to generate the encrypted representation of the second set of subentries.
7. The method of any one of the preceding embodiments, wherein executing the one or more operations to transform the subset of subentries comprises: concatenating each subentry of the second set of subentries to generate concatenated data; in response to concatenating each subentry, updating the concatenated data by converting characters of the concatenated data into a binary representation; in response to updating the concatenated data, compressing the concatenated data to generate a compact representation of the concatenated data; and encrypting the compact representation to generate the encrypted representation of the second set of subentries.
8. The method of any one of the preceding embodiments, wherein generating, for each entry of the first dataset, the encrypted representation of the second set of subentries comprises: encrypting a compressed representation of the second set of subentries to generate the encrypted representation of the second set of subentries; and generating an encoded representation of the second set of subentries based on the encrypted representation of the second set of subentries.
9. The method of any one of the preceding embodiments, wherein generating the augmented dataset comprises: decrypting the portion of the third dataset to generate the third set of subentries comprising the supplemental data; and updating the first dataset by appending the third set of subentries to corresponding entries of the plurality of entries.
10. The method of any one of the preceding embodiments, wherein updating the first dataset comprises: determining a correspondence between the second set of subentries and the first dataset; and updating the first dataset by appending subentries of the third set of subentries to entries of the first dataset based on the correspondence.
11. The method of any one of the preceding embodiments, further comprising: decoding the third set of subentries to extract the portion of the third dataset; wherein decrypting the portion of the third dataset comprises: decrypting the portion of the third dataset in response to decoding the third set of subentries.
12. The method of any one of the preceding embodiments, further comprising: decompressing the portion of the third dataset generate a representation of concatenated data represented by the third dataset; parsing the concatenated data to generate the second set of subentries and the third set of subentries; and in response to comparing the second set of subentries and the third set of subentries to the first dataset, determining the third set of subentries, wherein updating the first dataset comprises: updating the first dataset in response to determining the third set of subentries.
13. The method of any one of the preceding embodiments, wherein determining the third set of subentries comprises: comparing header values associated with the second set of subentries and the third set of subentries to determine the third set of subentries.
14. The method of any one of the preceding embodiments, further comprising: in response to decrypting a portion of the third dataset, determining that one or more aspects of the portion of the first dataset match one or more aspects of the third dataset; and validating the third dataset based on the one or more aspects of the portion of the first dataset matching the one or more aspects of the third dataset.
15. The method of any one of the preceding embodiments, further comprising: in response to generating the augmented dataset, comparing one or more aspects of the augmented dataset to the first dataset to determine a status; and validating comprising the first set of subentries, the second set of subentries, and a third set of subentries comprising the supplemental data.
16. One or more non-transitory, computer-readable mediums storing instructions that, when executed by a data processing apparatus, cause the data processing apparatus to perform operations comprising those of any of embodiments 1–15.
17. A system comprising one or more processors; and memory storing instructions that, when executed by the processors, cause the processors to effectuate operations comprising those of any of embodiments 1–15.
18. A system comprising means for performing any of embodiments 1–15.

What is claimed is:

1. A system for protecting portions of a dataset when communicating with devices outside of a domain, the system comprising:
one or more processors configured to perform operations comprising:
obtaining a plurality of entries from a first dataset, where each entry of the plurality of entries comprises a first set of subentries comprising sensitive data associated with a user profile and a second set of subentries comprising network operation data representing one or more network operations involving the user profile;
generating, for each entry of the first dataset, a user identifier based on the second set of subentries, and an encrypted representation of the second set of subentries;
generating a second dataset to remove the second set of subentries based on generating the encrypted representation of the first set of subentries for each entry of the first dataset;
providing, to a device, the second dataset to cause the device to execute one or more operations based on the second dataset;
obtaining, from the device, a third dataset comprising the second dataset and supplemental data associated with each entry of the second dataset; and
in response to decrypting a portion of the third dataset, generating an augmented dataset comprising the first set of subentries, the second set of subentries, and a third set of subentries comprising the supplemental data, the augmented dataset reestablishing the second set of subentries for each entry of the plurality of entries.

2. A method, comprising:
obtaining a plurality of entries from a first dataset, where each entry of the plurality of entries comprises a first set of subentries and a second set of subentries;
generating, for each entry of the first dataset, a user identifier based on the second set of subentries and an encrypted representation of the second set of subentries;
generating a second dataset to remove the second set of subentries based on generating the encrypted representation of the first set of subentries for each entry of the first dataset;
providing, to a device, the second dataset to cause the device to execute one or more operations based on the second dataset;
obtaining, from the device, a third dataset comprising the second dataset and supplemental data associated with each entry of the second dataset; and
in response to decrypting a portion of the third dataset, generating an augmented dataset comprising the first set of subentries, the second set of subentries, and a third set of subentries comprising the supplemental data.

3. The method of claim 2, further comprising:
for each entry of the first dataset,
determining a context for each subentry of the first set of subentries and the second set of subentries, the context indicating that data of each subentry is associated with a first data type or a second data type; and
determining the first set of subentries and the second set of subentries based on the context for each subentry.

4. The method of claim 2, wherein generating, for each entry of the first dataset, the user identifier comprises:
identifying at least a subset of subentries from among the first set of subentries; and
executing one or more operations to transform the subset of subentries into the user identifier.

5. The method of claim 2, wherein generating, for each entry of the first dataset, the encrypted representation of the second set of subentries comprises:
identifying at least a subset of subentries from among the second set of subentries; and
executing one or more operations to transform the subset of subentries into the encrypted representation of the second set of subentries.

6. The method of claim 5, wherein executing the one or more operations to transform the subset of subentries comprises:
concatenating each entry subentry of the second set of subentries to generate concatenated data; and
encrypting the concatenated data to generate the encrypted representation of the second set of subentries.

7. The method of claim 5, wherein executing the one or more operations to transform the subset of subentries comprises:
concatenating each subentry of the second set of subentries to generate concatenated data;
in response to concatenating each subentry, updating the concatenated data by converting characters of the concatenated data into a binary representation;
in response to updating the concatenated data, compressing the concatenated data to generate a compact representation of the concatenated data; and
encrypting the compact representation to generate the encrypted representation of the second set of subentries.

8. The method of claim 2, wherein generating, for each entry of the first dataset, the encrypted representation of the second set of subentries comprises:
encrypting a compressed representation of the second set of subentries to generate the encrypted representation of the second set of subentries; and
generating an encoded representation of the second set of subentries based on the encrypted representation of the second set of subentries.

9. The method of claim 2, wherein generating the augmented dataset comprises:
decrypting the portion of the third dataset to generate the third set of subentries comprising the supplemental data; and
updating the first dataset by appending the third set of subentries to corresponding entries of the plurality of entries.

10. The method of claim 9, wherein updating the first dataset comprises:
determining a correspondence between the second set of subentries and the first dataset; and
updating the first dataset by appending subentries of the third set of subentries to entries of the first dataset based on the correspondence.

11. The method of claim 9, further comprising:
decoding the third set of subentries to extract the portion of the third dataset;
wherein decrypting the portion of the third dataset comprises:
decrypting the portion of the third dataset in response to decoding the third set of subentries.

12. The method of claim 9, further comprising:
decompressing the portion of the third dataset generate a representation of concatenated data represented by the third dataset;
parsing the concatenated data to generate the second set of subentries and the third set of subentries; and
in response to comparing the second set of subentries and the third set of subentries to the first dataset, determining the third set of subentries,
wherein updating the first dataset comprises:
updating the first dataset in response to determining the third set of subentries.

13. The method of claim 12, wherein determining the third set of subentries comprises: comparing header values associated with the second set of subentries and the third set of subentries to determine the third set of subentries.

14. The method of claim 2, further comprising:
in response to decrypting a portion of the third dataset, determining that one or more aspects of the portion of the first dataset match one or more aspects of the third dataset; and
validating the third dataset based on the one or more aspects of the portion of the first dataset matching the one or more aspects of the third dataset.

15. The method of claim 2, further comprising:
in response to generating the augmented dataset, comparing one or more aspects of the augmented dataset to the first dataset to determine a status; and
validating comprising the first set of subentries, the second set of subentries, and a third set of subentries comprising the supplemental data.

16. One or more non-transitory, computer-readable mediums comprising instructions that, when executed by one or more processors, cause the one or more processors to perform operations comprising:
obtaining a plurality of entries from a first dataset, where each entry of the plurality of entries comprises a first set of subentries and a second set of subentries;
generating, for each entry of the first dataset, a user identifier based on the second set of subentries and an encrypted representation of the second set of subentries;
generating a second dataset to remove the second set of subentries based on generating the encrypted representation of the first set of subentries for each entry of the first dataset;
providing, to a device, the second dataset to cause the device to execute one or more operations based on the second dataset;
obtaining, from the device, a third dataset comprising the second dataset and supplemental data associated with each entry of the second dataset; and
in response to decrypting a portion of the third dataset, generating an augmented dataset comprising the first set of subentries, the second set of subentries, and a third set of subentries comprising the supplemental data.

17. The one or more non-transitory, computer-readable mediums of claim 16, wherein the instructions further cause the one or more processors to:
for each entry of the first dataset,
determine a context for each subentry of the first set of subentries and the second set of subentries, the context indicating that data of each subentry is associated with a first data type or a second data type; and
determine the first set of subentries and the second set of subentries based on the context for each subentry.

18. The one or more non-transitory, computer-readable mediums of claim 16, wherein the instructions that cause the one or more processors to generate, for each entry of the first dataset, the user identifier cause the one or more processors to:
identify at least a subset of subentries from among the first set of subentries; and
execute one or more operations to transform the subset of subentries into the user identifier.

19. The one or more non-transitory, computer-readable mediums of claim 16, wherein the instructions that cause the one or more processors to generate, for each entry of the first dataset, the encrypted representation of the second set of subentries cause the one or more processors to:
identify at least a subset of subentries from among the second set of subentries; and
execute one or more operations to transform the subset of subentries into the encrypted representation of the second set of subentries.

20. The one or more non-transitory, computer-readable mediums of claim 19, wherein the instructions that cause the one or more processors to execute the one or more operations to transform the subset of subentries cause the one or more processors to:
concatenate each entry subentry of the second set of subentries to generate concatenated data; and
encrypt the concatenated data to generate the encrypted representation of the second set of subentries.
